(19) United States
(12) Patent Application Publication
(10) Pub. No.: US 2026/0051081 A1
(43) Pub. Date: Feb. 19, 2026

(54) RESIDUAL CONTEXT USING PREDICTION INDEX

(71) Applicant: Tencent America LLC, Palo Alto, CA (US)

(72) Inventors: Ting-Lan LIN, Palo Alto, CA (US); Shan Liu, Palo Alto, CA (US)

(73) Assignee: Tencent America LLC, Palo Alto, CA (US)

(21) Appl. No.: 19/189,387

(22) Filed: Apr. 25, 2025

Related U.S. Application Data
(60) Provisional application No. 63/683,239, filed on Aug. 14, 2024.

(51) Int. Cl. G06T 9/00

(52) U.S. Cl. CPC G06T 9/001

(57) ABSTRACT

A method performed by at least one processor in an encoder includes receiving a polygon mesh comprising a plurality of vertices; predicting a vertex using an original vertex from the plurality of vertices; determining a residual between the predicted vertex and the original vertex; determining a residual context from a plurality of residual contexts; encoding the residual between the predicted vertex and the original vertex using the residual context; generating a bitstream including (i) the encoded residual, and (ii) a plurality of indexes identifying the residual context including (a) three indexes from the plurality indexes when the residual is associated with a geometric position of the predicted vertex, and (b) two indexes from the plurality of indexes when the residual is associated with an attribute of the predicted vertex.

### CROSS-REFERENCE TO RELATED APPLICATION

This application claims priority from U.S. Provisional Application No. 63/683,239 filed on Aug. 14, 2024, the disclosure of which is incorporated herein by reference in its entirety.

### FIELD

This disclosure is directed to a set of advanced video coding technologies. More specifically, the present disclosure is directed to a method and apparatus for residual context using prediction index.

### BACKGROUND

Video-based dynamic mesh coding (V-DMC) is an ongoing MPEG standard to compress dynamic meshes. The current V-DM C reference software compresses meshes based on decimated base meshes, displacements vectors and motion fields. The displacements are calculated by searching the closest point on the input mesh with respect to each vertex of the subdivided based mesh. To encode the displacement, displacement vectors are transformed into wavelet coefficients by a linear lifting scheme, and then the coefficients are quantized and coded by a video codec or arithmetic codec. This process also refines the base mesh to minimize the displacement. Texture transfer may be performed to match the texture with reparameterized geometry and UV as well as optimized texture for image compression.

In Test Model 3.0, the residual context model residualCtxs is used to perform residual bit estimation (estimateResidualBits) and residual encoding (encodeResidual). The residual context model in geometry uses ctxIndex and residueGroup as 2 dimensional features (ACExpGolombContext<8> residualCtxs[6][3]), whereas that in attribute uses only ctxIndex as 1 dimensional feature (ACExpGolombContext<6> residualCtxs[8])

### SUMMARY

According to an embodiment of the disclosure, a method performed by at least one processor in an encoder includes receiving a polygon mesh comprising a plurality of vertices; predicting a vertex using an original vertex from the plurality of vertices; determining a residual between the predicted vertex and the original vertex; determining a residual context from a plurality of residual contexts; encoding the residual between the predicted vertex and the original vertex using the residual context; generating a bitstream including (i) the encoded residual, and (ii) a plurality of indexes identifying the residual context including (a) three indexes from the plurality indexes when the residual is associated with a geometric position of the predicted vertex, and (b) two indexes from the plurality of indexes when the residual is associated with an attribute of the predicted vertex.

According to an embodiment of the disclosure, a method performed by at least one processor in decoder including receiving a bitstream that includes (i) an encoded residual associated with a predicted vertex of a polygon mesh that comprises a plurality of vertices, (ii) a plurality of indexes identifying a residual context including (a) three indexes from the plurality indexes when the residual context is associated with a geometric position of the predicted vertex, and (b) two indexes from the plurality of indexes when the residual context is associated with an attribute of the predicted vertex; determining the residual context using the plurality of indexes; decoding the encoded residual using the residual context; and decoding the predicted vertex using the residual.

According to an embodiment of the disclosure, a method performed by at least one processor includes: processing a polygon mesh comprising a plurality of vertices, wherein a vertex is predicted using an original vertex from the plurality of vertices, wherein a residual is determined between the predicted vertex and the original vertex, wherein a residual context is determined from a plurality of residual contexts; wherein the residual between the predicted vertex and the original vertex is encoded using the residual context; wherein a bitstream including (i) the encoded residual, and (ii) a plurality of indexes identifying the residual context including (a) three indexes from the plurality indexes when the residual is associated with a geometric position of the predicted vertex, and (b) two indexes from the plurality of indexes when the residual is associated with an attribute of the predicted vertex is generated.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of a block diagram of a communication system, in accordance with embodiments of the present disclosure.

FIG. 2 is a schematic illustration of a block diagram of a streaming system, in accordance with embodiments of the present disclosure.

FIG. 3 is a schematic illustration of an example mesh encoder, in accordance with embodiments of the present disclosure.

FIG. 4 illustrates an example of a modified residual Ctxs in a geometry encoder, in accordance with embodiments of the present disclosure.

FIG. 5 illustrates example of a modified residual Ctxs in a geometry decoder, in accordance with embodiments of the present disclosure.

FIG. 6 illustrates an example of a modified residual Ctxs in a geometry encoder, in accordance with embodiments of the present disclosure.

FIG. 7 illustrates example of a modified residual Ctxs in a geometry decoder, in accordance with embodiments of the present disclosure.

FIGS. 8-13 illustrate results comparing the embodiments of the present disclosure to Test Model 3.0.

FIG. 14 is a flowchart of an example process for encoding a residual, in accordance with embodiments of the present disclosure.

FIG. 15 is a diagram of a computer system suitable for implementing the embodiments of the present disclosure, in accordance with embodiment of the present disclosure.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

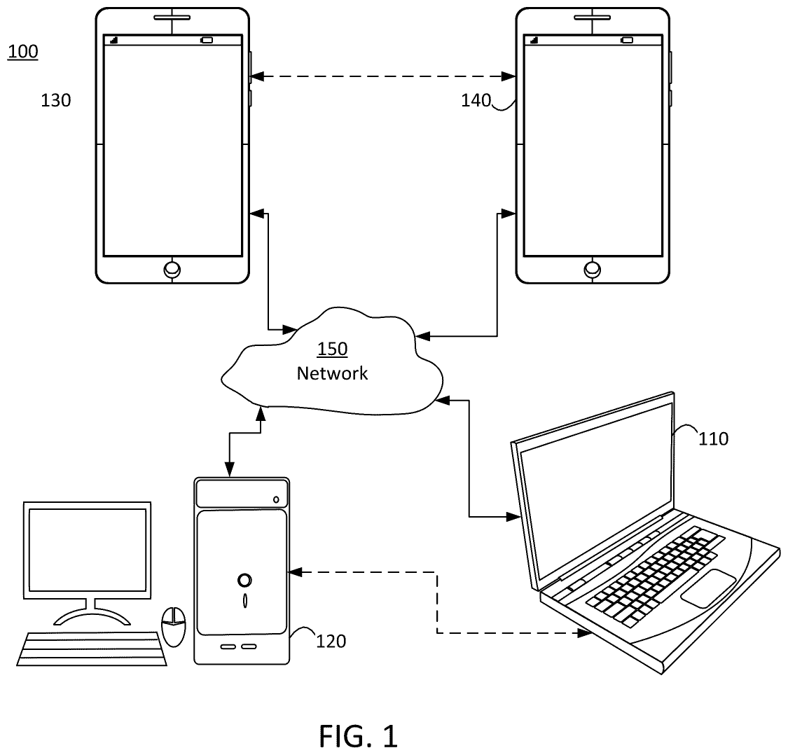

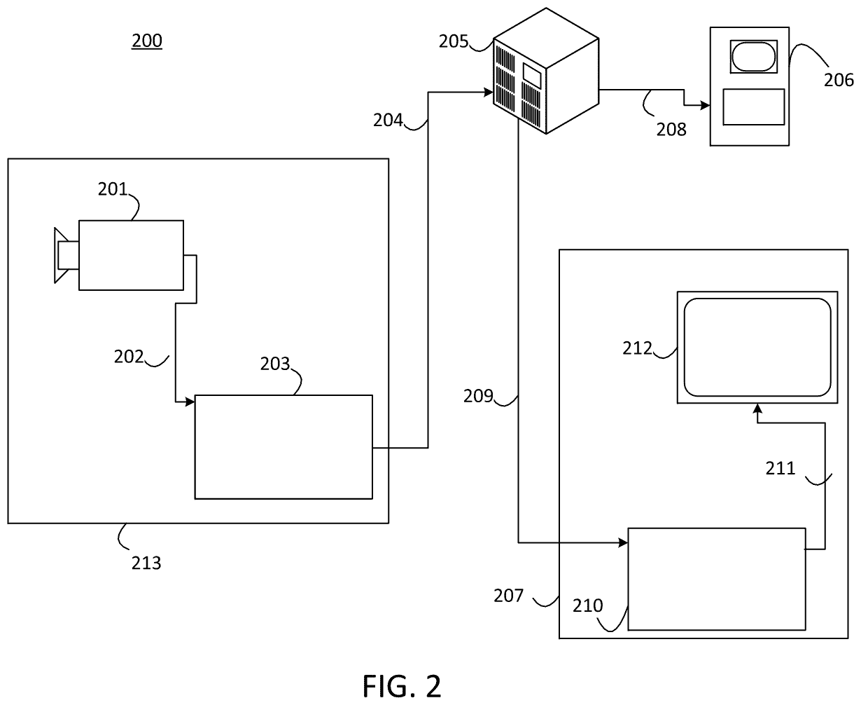

With reference to FIGS. 1-2, one or more embodiments of the present disclosure for implementing encoding and decoding structures of the present disclosure are described.

FIG. 1 illustrates a simplified block diagram of a communication system 100 according to an embodiment of the present disclosure. The system 100 may include at least two terminals 110, 120 interconnected via a network 150. For unidirectional transmission of data, a first terminal 110 may code video data, which may include mesh data, at a local location for transmission to the other terminal 120 via the network 150. The second terminal 120 may receive the coded video data of the other terminal from the network 150, decode the coded data and display the recovered video data. Unidirectional data transmission may be common in media serving applications and the like.

FIG. 1 illustrates a second pair of terminals 130, 140 provided to support bidirectional transmission of coded video that may occur, for example, during videoconferencing. For bidirectional transmission of data, each terminal 130, 140 may code video data captured at a local location for transmission to the other terminal via the network 150. Each terminal 130, 140 also may receive the coded video data transmitted by the other terminal, may decode the coded data and may display the recovered video data at a local display device.

In FIG. 1, the terminals 110-140 may be, for example, servers, personal computers, and smart phones, and/or any other type of terminals. For example, the terminals (110-140) may be laptop computers, tablet computers, media players and/or dedicated video conferencing equipment. The network 150 represents any number of networks that convey coded video data among the terminals 110-140 including, for example, wireline and/or wireless communication networks. The communication network 150 may exchange data in circuit-switched and/or packet-switched channels. Representative networks include telecommunications networks, local area networks, wide area networks, and/or the Internet. For the purposes of the present discussion, the architecture and topology of the network 150 may be immaterial to the operation of the present disclosure unless explained herein below.

FIG. 2 illustrates, as an example of an application for the disclosed subject matter, a placement of a video encoder and decoder in a streaming environment. The disclosed subject matter may be used with other video enabled applications, including, for example, video conferencing, digital TV, storing of compressed video on digital media including CD, DVD, memory stick and the like, and so on.

As illustrated in FIG. 2, a streaming system 200 may include a capture subsystem 213 that includes a video source 201 and an encoder 203. The streaming system 200 may further include at least one streaming server 205 and/or at least one streaming client 206.

The video source 201 may create, for example, a stream 202 that includes a 3D mesh and metadata associated with the 3D mesh. The video source 201 may include, for example, 3D sensors (e.g. depth sensors) or 3D imaging technology (e.g. digital camera(s)), and a computing device that is configured to generate the 3D mesh using the data received from the 3D sensors or the 3D imaging technology. The sample stream 202, which may have a high data volume when compared to encoded video bitstreams, may be processed by the encoder 203 coupled to the video source 201. The encoder 203 may include hardware, software, or a combination thereof to enable or implement aspects of the disclosed subject matter as described in more detail below. The encoder 203 may also generate an encoded video bitstream 204. The encoded video bitstream 204, which may have a lower data volume when compared to the uncompressed stream 202, may be stored on a streaming server 205 for future use. One or more streaming clients 206 and 207 may access the streaming server 205 to retrieve video bit streams 208 and 209, respectively that may be copies of the encoded video bitstream 204.

The streaming clients 207 may include a video decoder 210 and a display 212. The video decoder 210 may, for example, decode video bitstream 209, which is an incoming copy of the encoded video bitstream 204, and create an outgoing video sample stream 211 that may be rendered on the display 212 or another rendering device (not depicted). In some streaming systems, the video bitstreams 204, 208, and 209 may be encoded according to certain video coding/compression standards.

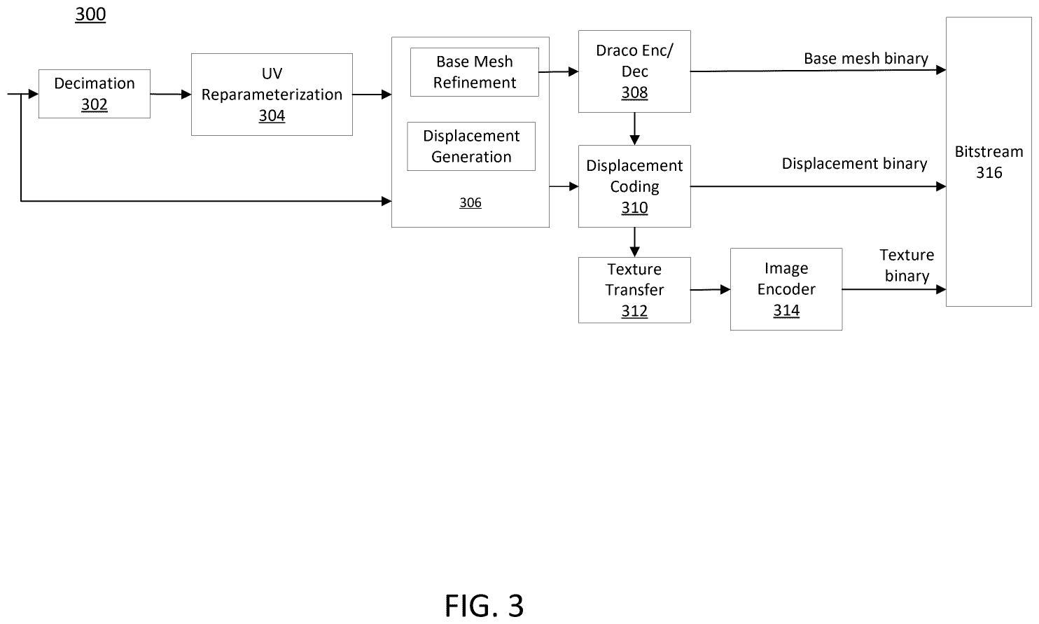

FIG. 3 illustrates an example mesh encoder 300. The encoder 300 may perform the V-DMC process for performing decimation and reparameterization before encoding a bitstream. As illustrated in FIG. 3, an input mesh may be subject to decimation 302 and UV reparameterization 304. Subsequently geometry reparameterization 306 is performed that includes base mesh refinement and displacement generation. The output of the base mesh refinement is provided to a Draco encoder 308 to generate a base mesh binary. The output of the displacement generation is provided to displacement coding 310 to generate displacement binary. The output of displacement coding 310 is provided to texture transfer 312 and image encoder 314 to generate texture binary. The base mesh binary, texture binary, and displacement binary may be included in bitstream 316. In one or more examples, texture coordinates or UV coordinates (often shortened to UVs) map the vertices to locations on the textures through a process called “UV Mapping”. The UVs define a 2D position in texture space for each vertex in the mesh.

In the embodiments of the present disclosure, one more dimension is added in residualCtxs to better separate the classes accumulating/updating the probability. According to one or more embodiments, predIndex is used, indicating the predictor index from 0 to 3, as the additional dimension. The index predIndex is used as an additional dimension of size 4 for residualCtxs for both Geometry and Attribute (Corner-based and Vertex-based), as shown in Table 1.

Table 1 illustrates an example residualCtxs for geometry and attribute by adding an additional dimension [4] for the predictor index (predIndex) from 0 to 3.

TABLE 1

| | |
|---|---|
| Geometry | ACExpGolombContext<8> residualCtxs[6][3][4]; |
| Attribute | ACExpGolombContext<6> residualCtxs[8][4]; |
| (Corner-based and | |
| Vertex-based) | |

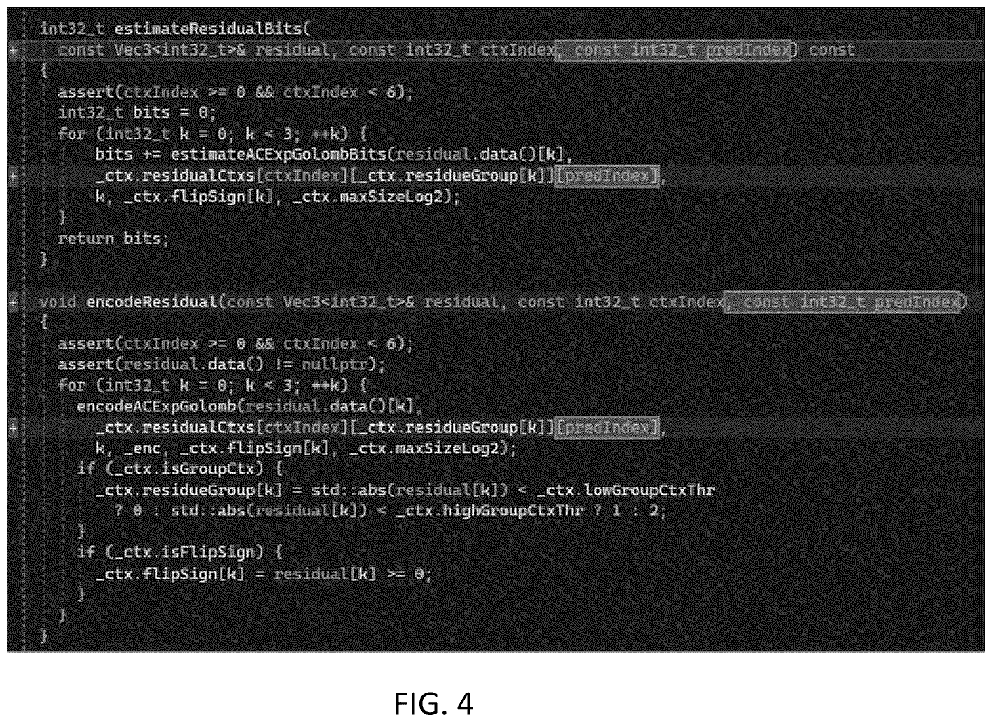

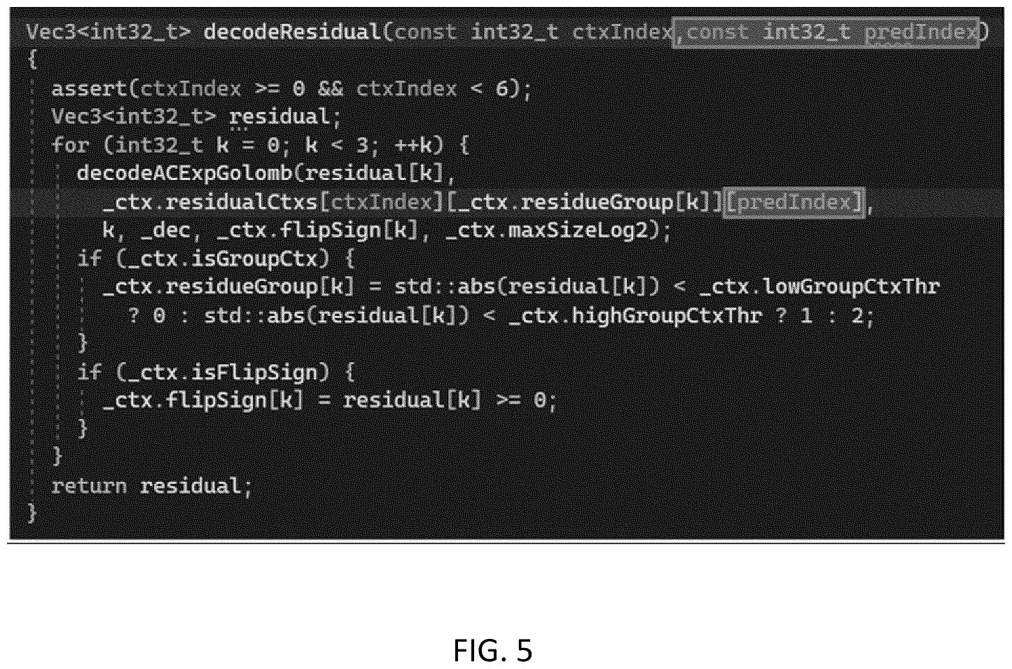

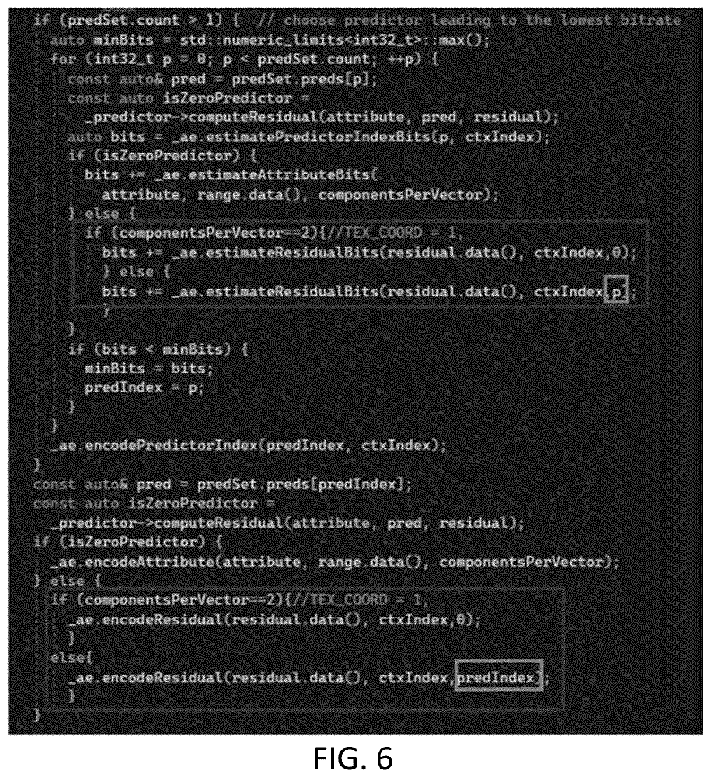

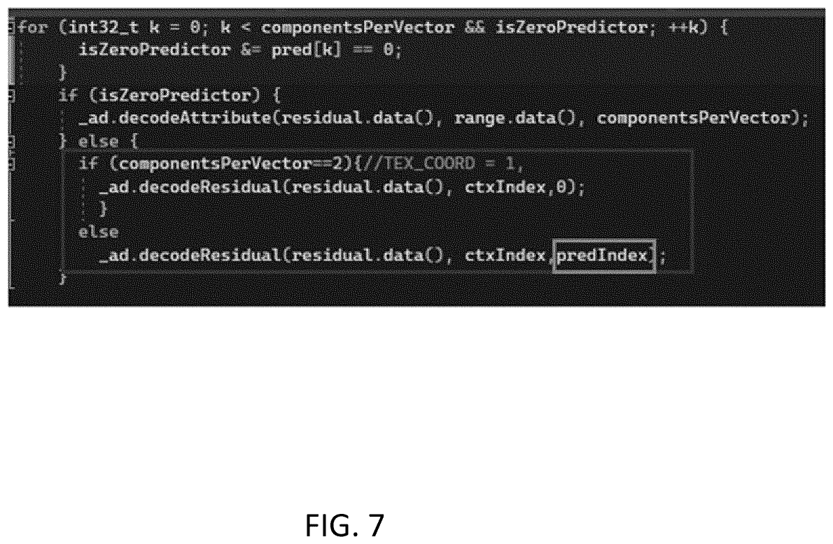

In one or more examples, the information of predIndex may be readily available (encoded/decoded) when residualCtxs is used. The changes of modified residualCtxs to be made may be in the encoder and decoder of geometry, corner-based attribute, and vertex-based attribute. Examples of change to the residual Ctxs for the encoder is illustrated in FIG. 4, and for the decoder is illustrated in FIG. 5. FIG. 6 illustrates another example encoder, and FIG. 7 illustrates another example decoder.

The residualCtxs[6][3][4] for geometry may refer to a position of a vertex. The residualCtxs[6][3][4] indicates that there are 6*3*4 (72) total residual contexts. The residualCtxs[8][4] for attribute my refer to texture attribute or color information attribute. The residualCtxs[8][4] indicates that there are 8*4 (32) total residual contexts.

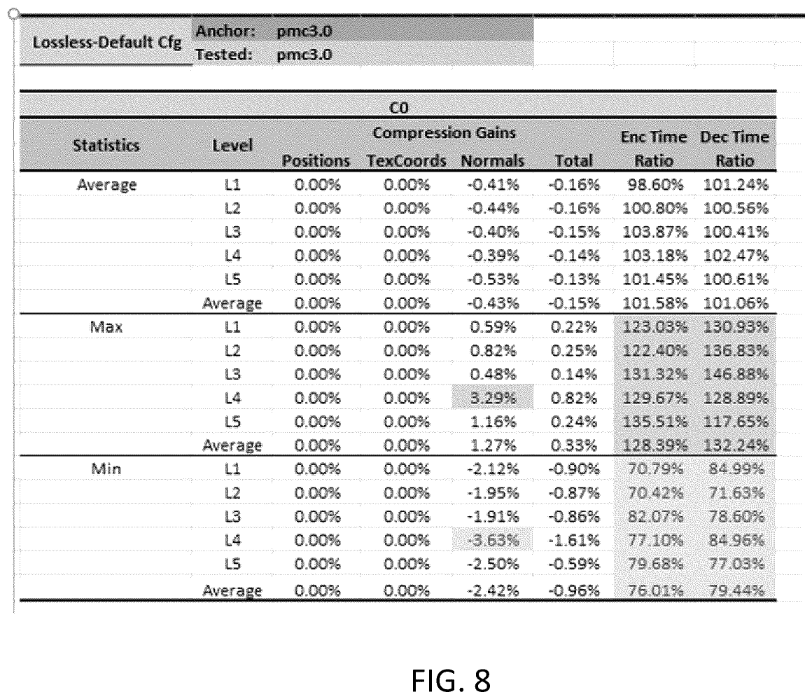

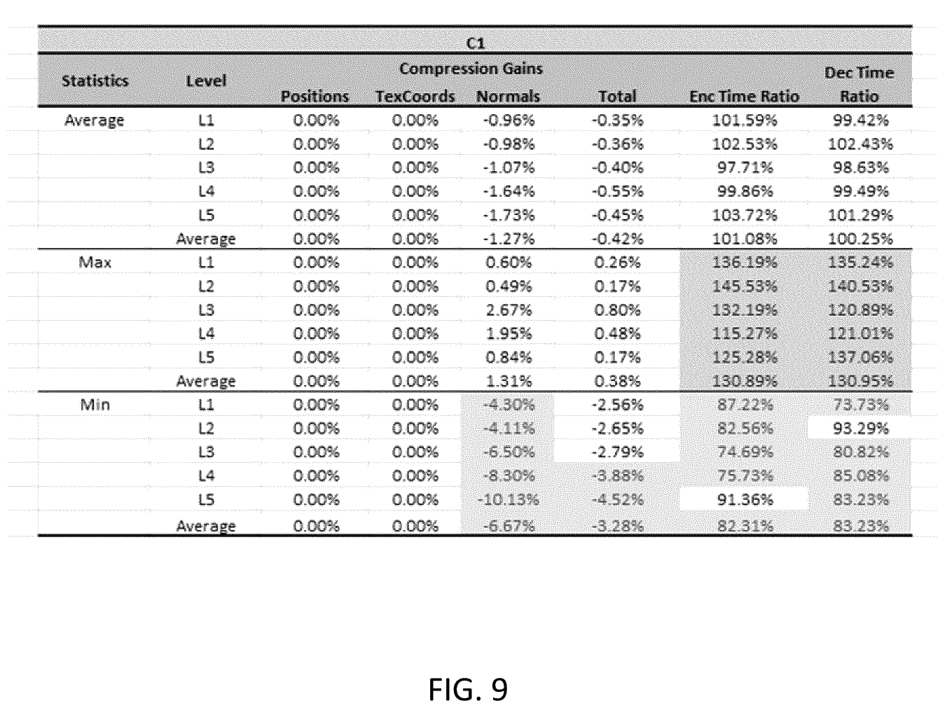

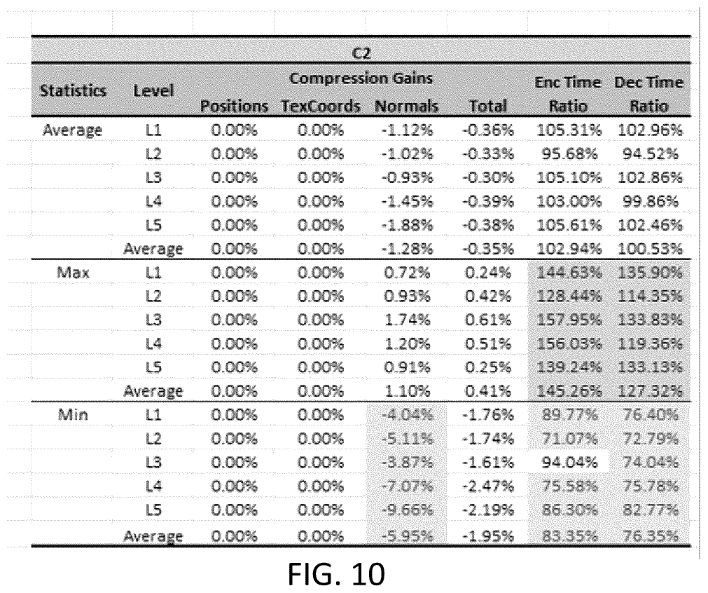

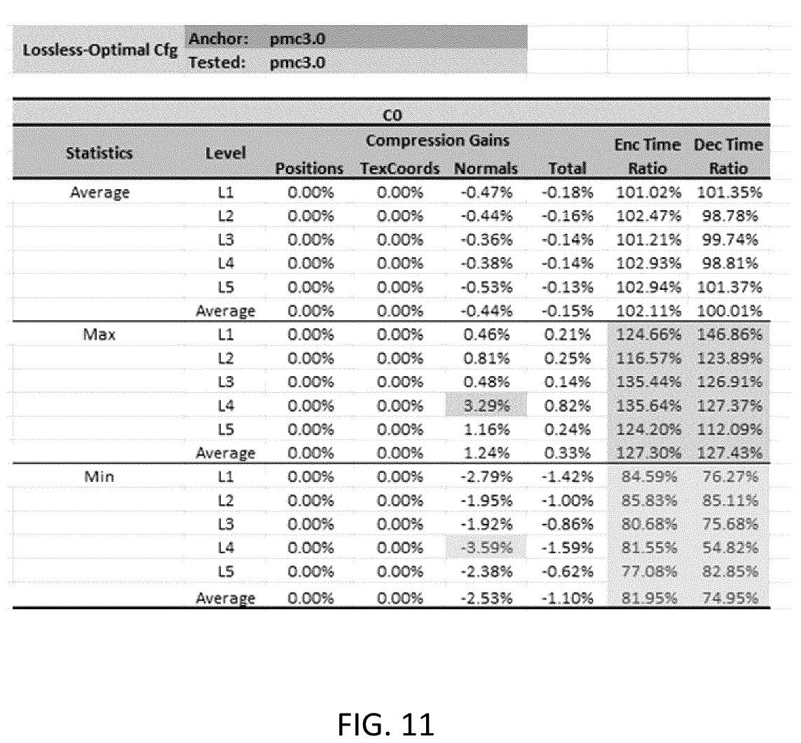

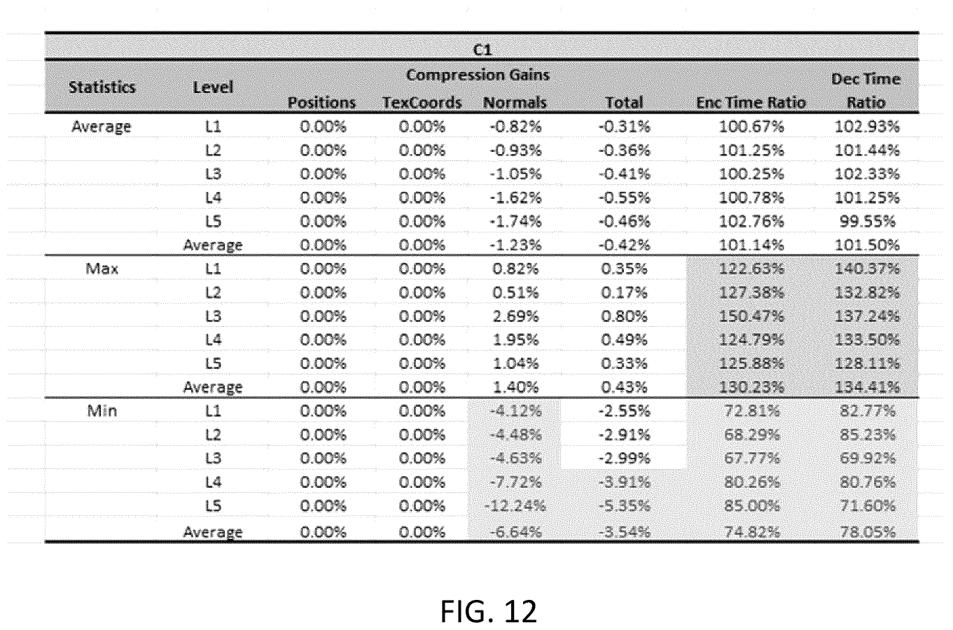

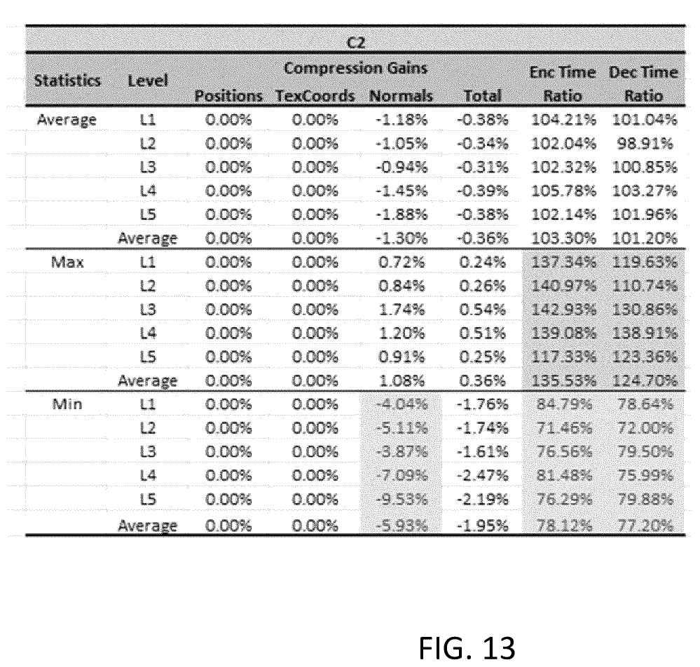

As illustrated in FIGS. 8-13, improvement can be observed in normal coding: average −0.43%, −1.27%, −1.28% for C0, C1 and C2 of default configuration, and −0.44%, −1.23% and −1.30% of per-mesh configuration. And the total gain is −0.15%, −0.42%, −0.35% and −0.15%, −0.42%, −0.36%. This shows the effectiveness of the proposed use of the predIndex as a feature in residual context.

The residual context model residualCtxs in coding in Test Model 3.0 uses ctxIndex to distinguish and update the probability. In this proposal, we further consider the coded information predIndex (indicating the coded predictor index) for context model. Compared with Test model 3.0, the Normal coding gains are −0.43%, −1.27%, −1.28% for C0, C1 and C2 of default configuration, and −0.44%, −1.23% and −1.30% of per-mesh configuration. And the total gain is-0.15%, −0.42%, −0.35% and −0.15%, −0.42%, −0.36% (see FIGS. 8-13).

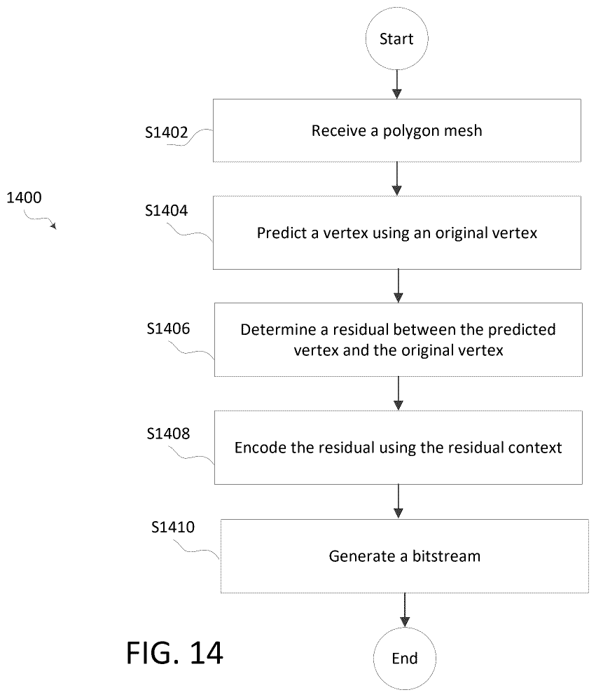

FIG. 14 is a flowchart of an example process 600 for encoding a residual. The process 1400 may be performed by the encoder 203 (FIG. 2).

The process may start at operation S1402 where a polygon mesh is received. The polygon mesh may comprise a plurality of vertices.

The process proceeds to operation S1404 where a vertex is predicted using an original vertex. The original vertex may be a vertex from the plurality of vertices.

The process proceeds to operation S1406 where a residual is determined between the predicted vertex and the original vertex. For example, the residual may be a difference between the predicted vertex and the original vertex.

The process proceeds to operation S1408 where a residual context is determined from a plurality of residual contexts. The plurality of residual contexts may correspond to residualCtxs[6][3][4] for a geometric position of a vertex, where the total number of residual contexts may be 6*3*4. The plurality of residual contexts may be residualCtxs[8][4] for an attribute (e.g., texture, color information), where the total number of residual contexts may be 8*4. The determined residual context may be a residual context that minimizes a number of bits or an error between the residual and the encoded residual.

The process proceeds to operation S1410 where the residual is encoded using the residual context.

The process proceeds to operation S1412 where a bitstream is generated. The bitstream may include the encoded residual and a plurality of indexes identifying the residual context. The plurality of indexes include three indexes when the residual is associated with a geometric position of the predicted vertex, and two indexes when the residual is associated with an attribute of the predicted vertex.

The decoder 210 may perform a decoding process on the bitstream generated by the encoder 203. The decoder 210 may determine the residual context based on the plurality of indexes included in the bitstream. The decoder 210 may decode the encoded residual using the residual context. The decoder may decode an original vertex of the polygon mesh using the residual and the predicted vertex.

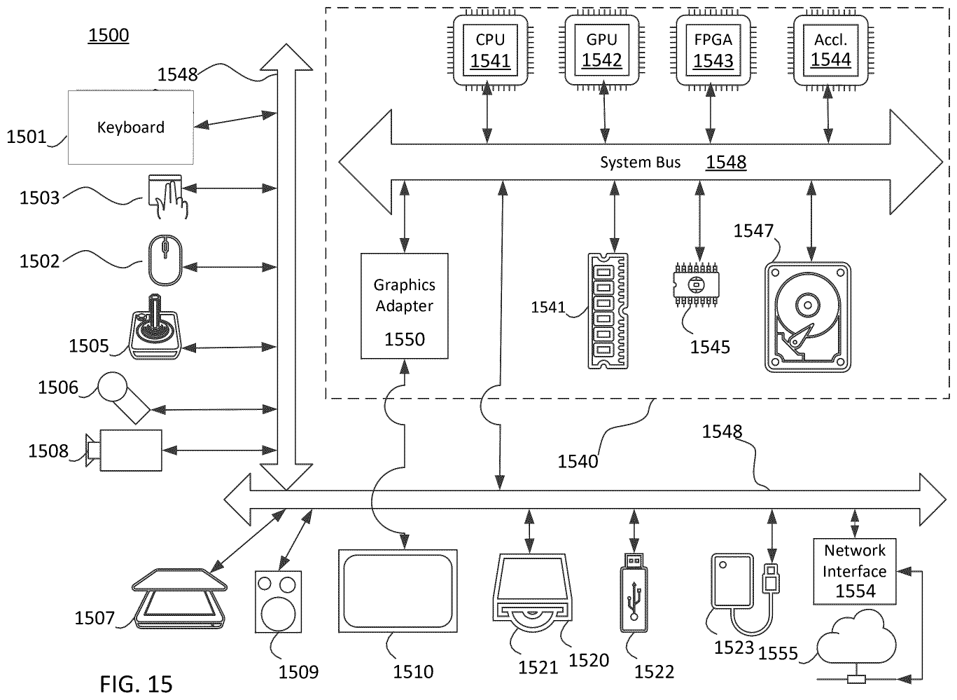

The techniques, described above, may be implemented as computer software using computer-readable instructions and physically stored in one or more computer-readable media. For example, FIG. 15 shows a computer system 1500 suitable for implementing certain embodiments of the disclosure.

The computer software may be coded using any suitable machine code or computer language, that may be subject to assembly, compilation, linking, or like mechanisms to create code including instructions that may be executed directly, or through interpretation, micro-code execution, and the like, by computer central processing units (CPUs), Graphics Processing Units (GPUs), and the like.

The instructions may be executed on various types of computers or components thereof, including, for example, personal computers, tablet computers, servers, smartphones, gaming devices, internet of things devices, and the like.

The components shown in FIG. 15 for computer system 1500 are examples and are not intended to suggest any limitation as to the scope of use or functionality of the computer software implementing embodiments of the present disclosure. Neither should the configuration of components be interpreted as having any dependency or requirement relating to any one or combination of components illustrated in the non-limiting embodiment of a computer system 1500.

Computer system 1500 may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices may also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard 1501, mouse 1502, trackpad 1503, touch screen 1510, data-glove, joystick 1505, microphone 1506, scanner 1507, camera 1508.

Computer system 1500 may also include certain human interface output devices. Such human interface output devices may be stimulating the senses of one or more human users through, for example, tactile output, sound, light, and smell/taste. Such human interface output devices may include tactile output devices (for example tactile feedback by the touch-screen 1510, data glove, or joystick 1505, but there may also be tactile feedback devices that do not serve as input devices). For example, such devices may be audio output devices (such as: speakers 1509, headphones (not depicted)), visual output devices (such as screens 1510 to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system 1500 may also include human accessible storage devices and their associated media such as optical media including CD/DVD ROM/RW 1520 with CD/DVD or the like media 1521, thumb-drive 1522, removable hard drive or solid state drive 1523, legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system 1500 may also include interface to one or more communication networks. Networks may be wireless, wireline, optical. Networks may further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses 1549 (such as, for example USB ports of the computer system 1500; others are commonly integrated into the core of the computer system 1500 by attachment to a system bus as described below (for example Ethernet interface into a PC computer system or cellular network interface into a smartphone computer system). Using any of these networks, computer system 1500 may communicate with other entities. Such communication may be uni-directional, receive only (for example, broadcast TV), uni-directional send-only (for example CAN bus to certain CAN bus devices), or bi-directional, for example to other computer systems using local or wide area digital networks. Such communication may include communication to a cloud computing environment 1555. Certain protocols and protocol stacks may be used on each of those networks and network interfaces as described above.

A forementioned human interface devices, human-accessible storage devices, and network interfaces 1554 may be attached to a core 1540 of the computer system 1500.

The core 1540 may include one or more Central Processing Units (CPU) 1541, Graphics Processing Units (GPU) 1542, specialized programmable processing units in the form of Field Programmable Gate Areas (FPGA) 1543, hardware accelerators for certain tasks 1544, and so forth. These devices, along with Read-only memory (ROM) 1545, Random-access memory 1546, internal mass storage such as internal non-user accessible hard drives, SSDs, and the like 1547, may be connected through a system bus 1548. In some computer systems, the system bus 1548 may be accessible in the form of one or more physical plugs to enable extensions by additional CPUs, GPU, and the like. The peripheral devices may be attached either directly to the core's system bus 1548, or through a peripheral bus 1549. Architectures for a peripheral bus include PCI, USB, and the like. A graphics adapter 1550 may be included in the core 1540.

CPUs 1541, GPUs 1542, FPGAs 1543, and accelerators 1544 may execute certain instructions that, in combination, may make up the aforementioned computer code. That computer code may be stored in ROM 1545 or RAM 1546. Transitional data may be also be stored in RAM 1546, whereas permanent data may be stored for example, in the internal mass storage 1547. Fast storage and retrieve to any of the memory devices may be enabled through the use of cache memory, that may be closely associated with one or more CPU 1541, GPU 1542, mass storage 1547, ROM 1545, RAM 1546, and the like.

The computer readable media may have computer code thereon for performing various computer-implemented operations. The media and computer code may be those specially designed and constructed for the purposes of the present disclosure, or they may be of the kind well known and available to those having skill in the computer software arts.

As an example and not by way of limitation, the computer system having architecture 1500, and specifically the core 1540 may provide functionality as a result of processor(s) (including CPUs, GPUs, FPGA, accelerators, and the like) executing software embodied in one or more tangible, computer-readable media. Such computer-readable media may be media associated with user-accessible mass storage as introduced above, as well as certain storage of the core 1540 that are of non-transitory nature, such as core-internal mass storage 1547 or ROM 1545. The software implementing various embodiments of the present disclosure may be stored in such devices and executed by core 1540. A computer-readable medium may include one or more memory devices or chips, according to particular needs. The software may cause the core 1540 and specifically the processors therein (including CPU, GPU, FPGA, and the like) to execute particular processes or particular parts of particular processes described herein, including defining data structures stored in RAM 1546 and modifying such data structures according to the processes defined by the software. In addition or as an alternative, the computer system may provide functionality as a result of logic hardwired or otherwise embodied in a circuit (for example: accelerator 1544), which may operate in place of or together with software to execute particular processes or particular parts of particular processes described herein. Reference to software may encompass logic, and vice versa, where appropriate. Reference to a computer-readable media may encompass a circuit (such as an integrated circuit (IC)) storing software for execution, a circuit embodying logic for execution, or both, where appropriate. The present disclosure encompasses any suitable combination of hardware and software.

While this disclosure has described several non-limiting embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the embodiments listed below:
(1) A method performed by at least one processor in an encoder includes receiving a polygon mesh comprising a plurality of vertices; predicting a vertex using an original vertex from the plurality of vertices; determining a residual between the predicted vertex and the original vertex; determining a residual context from a plurality of residual contexts; encoding the residual between the predicted vertex and the original vertex using the residual context; generating a bitstream including (i) the encoded residual, and (ii) a plurality of indexes identifying the residual context including (a) three indexes from the plurality indexes when the residual is associated with a geometric position of the predicted vertex, and (b) two indexes from the plurality of indexes when the residual is associated with an attribute of the predicted vertex.
(2) The method according to feature (1), in which the plurality of indexes include a predictor index.
(3) The method according to feature (2), in which the predictor index is an integer value that ranges from 0 to 3.
(4) The method according to any one of features (1)-(3), in which the determining the residual context from the plurality of residual context further comprises determining the residual context that minimizes a number of bits for encoding the residual.
(5) The method according to any one of features (1)-(4), in which the determining the residual context from the plurality of residual context further comprises determining the residual context that minimizes an error between the residual context and the encoded residual context.
(6) The method according to any one of features (1)-(5), in which the attribute of the predicted vertex includes texture information or color information.
(7) The method according to any one of features (1)-(6), in which a number of the plurality of indexes is a product of the first index, the second index, and the third index when the residual context is associated with the geometric position of the predicted vertex.
(8) The method according to any one of features (1)-(7) in which a number of the plurality of indexes is a product of the first index and the second index when the residual context is associated with the attribute of the predicted vertex.
(9) A method performed by at least one processor in decoder, the method including: receiving a bitstream that includes (i) an encoded residual associated with a predicted vertex of a polygon mesh that comprises a plurality of vertices, (ii) a plurality of indexes identifying a residual context including (a) three indexes from the plurality indexes when the residual context is associated with a geometric position of the predicted vertex, and (b) two indexes from the plurality of indexes when the residual context is associated with an attribute of the predicted vertex; determining the residual context using the plurality of indexes; decoding the encoded residual using the residual context; and decoding the predicted vertex using the residual.
(10) The method according to feature (9), in which the plurality of indexes include a predictor index.
(11) The method according to feature (10), in which the predictor index is an integer value that ranges from 0 to 3.
(12) The method according to any one of features (9)-(11), in which the determined residual context is a residual context from a plurality of residual contexts that minimizes a number of bits for encoding the residual.
(13) The method according to any one of features (9)-(12), in which the determined the residual context is a residual context from the plurality of residual contexts that minimizes an error between the residual context and the encoded residual context.
(14) The method according to any one of features (9)-(13), in which the attribute of the predicted vertex includes texture information or color information.
(15) The method according to feature (13) or (14), in which a number of the plurality of indexes is a product of the first index, the second index, and the third index when the residual context is associated with the geometric position of the predicted vertex.
(16) The method according to any one of features (13)-(15), in which a number of the plurality of indexes is a product of the first index and the second index when the residual context is associated with the attribute of the predicted vertex.
(17) A method performed by at least one processor, the method including: processing a polygon mesh comprising a plurality of vertices, in which a vertex is predicted using an original vertex from the plurality of vertices, in which a residual is determined between the predicted vertex and the original vertex, in which a residual context is determined from a plurality of residual contexts; in which the residual between the predicted vertex and the original vertex is encoded using the residual context; in which a bitstream including (i) the encoded residual, and (ii) a plurality of indexes identifying the residual context including (a) three indexes from the plurality indexes when the residual is associated with a geometric position of the predicted vertex, and (b) two indexes from the plurality of indexes when the residual is associated with an attribute of the predicted vertex is generated.
(18) The method according to feature (17), in which the plurality of indexes include a predictor index.
(19) The method according to feature (18), in which the predictor index is an integer value that ranges from 0 to 3.
(20) The method according to any one of features (17)-(19), in which the residual context is determined from the plurality of residual context further comprises determining the residual context that minimizes a number of bits for encoding the residual.

What is claimed is:

1. A method performed by at least one processor in an encoder, the method comprising:
receiving a polygon mesh comprising a plurality of vertices;
predicting a vertex using an original vertex from the plurality of vertices;
determining a residual between the predicted vertex and the original vertex;
determining a residual context from a plurality of residual contexts;
encoding the residual between the predicted vertex and the original vertex using the residual context;
generating a bitstream including (i) the encoded residual, and (ii) a plurality of indexes identifying the residual context including (a) three indexes from the plurality indexes when the residual is associated with a geometric position of the predicted vertex, and (b) two indexes from the plurality of indexes when the residual is associated with an attribute of the predicted vertex.

2. The method according to claim 1, wherein the plurality of indexes include a predictor index.

3. The method according to claim 2, wherein the predictor index is an integer value that ranges from 0 to 3.

4. The method according to claim 1, wherein the determining the residual context from the plurality of residual context further comprises determining the residual context that minimizes a number of bits for encoding the residual.

5. The method according to claim 1, wherein the determining the residual context from the plurality of residual context further comprises determining the residual context that minimizes an error between the residual context and the encoded residual context.

6. The method according to claim 1, wherein the attribute of the predicted vertex includes texture information or color information.

7. The method according to claim 1, wherein a number of the plurality of indexes is a product of the first index, the second index, and the third index when the residual context is associated with the geometric position of the predicted vertex.

8. The method according to claim 1 wherein a number of the plurality of indexes is a product of the first index and the second index when the residual context is associated with the attribute of the predicted vertex.

9. A method performed by at least one processor in decoder, the method comprising:
receiving a bitstream that includes (i) an encoded residual associated with a predicted vertex of a polygon mesh that comprises a plurality of vertices, (ii) a plurality of indexes identifying a residual context including (a) three indexes from the plurality indexes when the residual context is associated with a geometric position of the predicted vertex, and (b) two indexes from the plurality of indexes when the residual context is associated with an attribute of the predicted vertex;
determining the residual context using the plurality of indexes;
decoding the encoded residual using the residual context; and
decoding the predicted vertex using the residual.

10. The method according to claim 9, wherein the plurality of indexes include a predictor index.

11. The method according to claim 10, wherein the predictor index is an integer value that ranges from 0 to 3.

12. The method according to claim 9, wherein the determined residual context is a residual context from a plurality of residual contexts that minimizes a number of bits for encoding the residual.

13. The method according to claim 9, wherein the determined the residual context is a residual context from the plurality of residual contexts that minimizes an error between the residual context and the encoded residual context.

14. The method according to claim 9, wherein the attribute of the predicted vertex includes texture information or color information.

15. The method according to claim 13, wherein a number of the plurality of indexes is a product of the first index, the second index, and the third index when the residual context is associated with the geometric position of the predicted vertex.

16. The method according to claim 13, wherein a number of the plurality of indexes is a product of the first index and the second index when the residual context is associated with the attribute of the predicted vertex.

17. A method performed by at least one processor, the method comprising:
processing a polygon mesh comprising a plurality of vertices,
wherein a vertex is predicted using an original vertex from the plurality of vertices,
wherein a residual is determined between the predicted vertex and the original vertex,
wherein a residual context is determined from a plurality of residual contexts;
wherein the residual between the predicted vertex and the original vertex is encoded using the residual context;
wherein a bitstream including (i) the encoded residual, and (ii) a plurality of indexes identifying the residual context including (a) three indexes from the plurality indexes when the residual is associated with a geometric position of the predicted vertex, and (b) two indexes from the plurality of indexes when the residual is associated with an attribute of the predicted vertex is generated.

18. The method according to claim 17, wherein the plurality of indexes include a predictor index.

19. The method according to claim 18, wherein the predictor index is an integer value that ranges from 0 to 3.

20. The method according to claim 17, wherein the residual context is determined from the plurality of residual context further comprises determining the residual context that minimizes a number of bits for encoding the residual.
